(19) United States
(12) Patent Application Publication
(10) Pub. No.: US 2019/0295413 A1
(43) Pub. Date: Sep. 26, 2019

(54) CONTROL APPARATUS FOR VEHICLE

(71) Applicant: DENSO CORPORATION, Kariya-city (JP)

(72) Inventors: Tomomi HASE, Kariya-city (JP); Noriaki IKEMOTO, Kariya-city (JP); Mitsuharu HIGASHITANI, Kariya-city (JP)

(73) Assignee: DENSO CORPORATION, Kariya-city (JP)

(21) Appl. No.: 16/364,673

(22) Filed: Mar. 26, 2019

(30) Foreign Application Priority Data
Mar. 26, 2018 (JP) 2018-057342

(51) Int. Cl. G08G 1/0968; B60R 11/04; G05D 1/12; G06K 9/00; G08G 1/16

(52) U.S. Cl. CPC G08G 1/096844; G08G 1/096827; B60R 11/04; G06K 2209/21; G06K 9/00812; G08G 1/166; G08G 1/168; G05D 1/12

(57) ABSTRACT

A control apparatus includes a detecting unit and a changing unit. The detecting unit detects whether an autonomous vehicle can stop at a destination when the autonomous vehicle moves towards the destination by automated driving and reaches the vicinity of the destination. The changing unit changes a stopping position to a location other than the destination when the detecting unit detects that the autonomous vehicle cannot stop at the destination.

### CROSS-REFERENCE TO RELATED APPLICATION

This application is based on and claims the benefit of priority from Japanese Patent Application No. 2018-057342, filed Mar. 26, 2018. The entire disclosure of the above application is incorporated herein by reference.

### BACKGROUND

### Technical Field

The present disclosure relates to a control apparatus for a vehicle.

### Related Art

Automated driving control of an autonomous vehicle, performed by a control apparatus, is known. In the automated driving control, the control apparatus may set an automated driving route to a destination such that the autonomous vehicle can move along the set automated driving route.

### SUMMARY

The present disclosure provides a control apparatus for a vehicle. The control apparatus detects whether an autonomous vehicle can stop at a destination when the autonomous vehicle moves towards the destination by automated driving and reaches the vicinity of the destination. The vehicle control apparatus changes a stopping position to a location other than the destination when it is detected that the autonomous vehicle cannot stop at the destination.

### BRIEF DESCRIPTION OF THE DRAWINGS

In the accompanying drawings:

FIG. 1 is a block diagram of an internal configuration of an autonomous vehicle;

FIG. 2 is a flowchart of a stopping position determination process according to a first embodiment;

FIG. 3 is a diagram of an example of a relationship between a building designated as a destination and an actual destination;

FIG. 4 is a flowchart of a detection process according to a second embodiment;

FIG. 5 is a flowchart of a changing process according to the second embodiment;

FIG. 6 is a flowchart of a destination changing process according to a third embodiment;

FIG. 7 is a flowchart of a retrieval process according to the third embodiment;

FIG. 8 is a flowchart of a circuit route setting process according to the third embodiment;

FIG. 9 is a diagram of an example of a circuit route;

FIG. 10 is a diagram of an example of a circuit route;

FIG. 11 is a diagram of an example of a circuit route; and

FIG. 12 is a flowchart of a moving process according to a fourth embodiment.

### DESCRIPTION OF THE EMBODIMENTS

Embodiments of the present disclosure relate to parking and stopping of an autonomous vehicle.

In a related technique, automated driving routes to be recommended are extracted from automated driving routes, based on the time required and tolls. Then, an automated driving route is selected from the extracted automated driving routes. Based on information of the selected automated driving route, a drive unit provided in the autonomous vehicle is controlled. Thus, automated driving control is performed such that the autonomous vehicle can move along the automated driving route.

The related technique considers setting of a route to a destination but does not consider whether at least one of parking or stopping can be performed after arrival at the destination. Hereafter, the term “stopping” may be used in cases in which parking and stopping are referred to in a collective manner. Even if an autonomous vehicle arrives at a location that is set as the destination, if the autonomous vehicle cannot be stopped, a person cannot board or exit the autonomous vehicle. It is thus desired to provide a measure against a situation in which an autonomous vehicle cannot be stopped upon arrival at a destination.

An exemplary embodiment provides a vehicle control apparatus that includes a detecting unit and a changing unit. The detecting unit detects whether an autonomous vehicle can stop at a destination when the autonomous vehicle moves towards the destination by automated driving and reaches the vicinity of the destination. The changing unit changes a stopping position to a location other than the destination when the detecting unit detects that the autonomous vehicle cannot stop at the destination.

According to the exemplary embodiment, the stopping position is changed to a location other than the destination when the autonomous vehicle cannot stop at the destination. Therefore, a measure can be taken against a situation in which the autonomous vehicle cannot stop at the destination.

Embodiments will hereinafter be described with reference to the accompanying drawings. To facilitate understanding of the descriptions, constituent elements in the drawings that are identical to each other are given the same reference numbers when possible. Redundant descriptions are omitted.

### First Embodiment

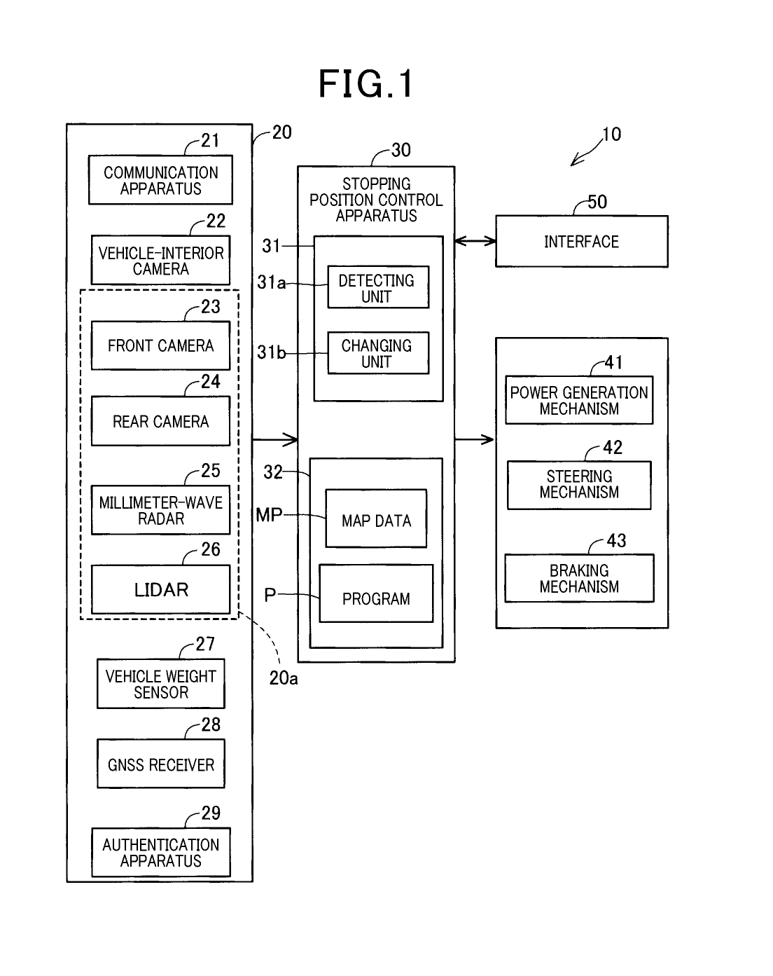

FIG. 1 shows an autonomous vehicle 10 according to a first embodiment. The autonomous vehicle 10 shown in FIG. 1 provides an automated driving function in which monitoring by a driver is not necessarily required, which corresponds to level 3 (conditional automation) or higher, i.e., level 4 (high automation) or level 5 (full automation) in six levels of driving automation, ranging from no driving automation (level 0) to full automation (level 5), defined by SAE (Society of Automotive Engineers) International Standard J3016. The autonomous vehicle 10 includes information acquisition apparatuses 20, a stopping position control apparatus (corresponding to the vehicle control apparatus) 30, a power generation mechanism 41, a steering mechanism 42, a braking mechanism 43, and an interface 50.

The information acquisition apparatuses 20 include a communication apparatus 21, a vehicle-interior camera 22, a front camera 23, a rear camera 24, a millimeter-wave radar 25, a LIDAR 26, a vehicle weight sensor 27, a global navigation satellite system (GNSS) receiver 28, and an authentication apparatus 29. Information acquired by these elements included in the information acquisition apparatuses 20 is received by the stopping position control apparatus 30. The front camera 23, the rear camera 24, the millimeter-wave radar 25, and the LIDAR 26 may be collectively referred to as an external sensor 20a. According to another embodiment, the external sensor 20a may include an ultrasonic sonar or other sensors. Alternatively, a portion of the foregoing sensors may not be included in the external sensor 20a.

The communication apparatus 21 performs wireless communication with an external communication apparatus. The GNSS receiver 28 determines a current position of the autonomous vehicle 10 in latitude and longitude based on navigation signals received from navigation satellites. The authentication apparatus 29 performs authentication of personal information. Detailed contents of the personal information will be described hereafter.

The vehicle-interior camera 22 captures an image of the interior of the autonomous vehicle 10. The front camera 23 is a single-lens camera that captures an image of an area outside the autonomous vehicle 10 or, specifically, an area ahead of the autonomous vehicle 10. The rear camera 24 is a single-lens camera that captures an image of an area outside the autonomous vehicle 10 or, specifically, an area to the rear of the autonomous vehicle 10. The millimeter-wave radar 25 is a radar that uses a millimeter-wave band. A sensing range of the millimeter-wave radar 25 includes the areas ahead, to the sides, and to the rear of the autonomous vehicle 10. The LIDAR 26 is a distance measurement apparatus that uses a laser. A sensing range of the LIDAR 26 includes the area ahead of the autonomous vehicle 10.

The power generation mechanism 41 is configured by at least one of an internal combustion engine and an electric motor. The steering mechanism 42 is a mechanism for steering front wheels of the autonomous vehicle 10. The braking mechanism 43 is a mechanism for decelerating the autonomous vehicle 10.

The interface 50 is a man-machine interface for input and output. Specifically, the interface 50 is configured by a touch panel, a speaker, a microphone, and the like.

The stopping position control apparatus 30 is configured by a single or a plurality of electronic control units (ECUs). The stopping position control apparatus 30 includes a central processing unit (CPU) 31 and a storage medium 32. For example, the storage medium 32 is configured by a non-transitory computer-readable storage medium such as a semiconductor memory.

The storage medium 32 stores therein map data MP and a program P. The map data MP includes information on parking areas and locations at which the autonomous vehicle 10 can be stopped. According to the present embodiment, parking and stopping are defined based on Japanese laws. Specifically, parking refers to any of (a) a vehicle being stopped in a state in which the driver is away from the vehicle and unable to immediately drive the vehicle, (b) a vehicle being continuously stopped while the driver is waiting for a person or cargo, even when the driver is not away from the vehicle, (c) loading and unloading of cargo that exceeds five minutes, (d) a vehicle being stopped due to a malfunction, and the like.

Stopping refers to any of (e) a vehicle being stopped to enable a person to board or exit the vehicle, (f) a vehicle being stopped for loading and unloading of cargo for five minutes or less, (g) a vehicle being stopped without the driver leaving the vehicle, and (h) a vehicle being stopped in a state in which the driver is able to immediately drive the vehicle, even when the driver is away from the vehicle.

No parking refers to cases in which, while parking is prohibited, stopping can be performed. No parking or stopping refers to cases in which both parking and stopping are prohibited. According to the present embodiment, the term “stopping” may be used when parking and stopping are not differentiated and are referred to in a collective manner. Stopping in this case does not include temporary stopping. Temporary stopping refers to a vehicle stopping when a road sign or the like at or near an intersection indicates that temporary stopping is required.

The program P is a program (i.e., a set of computer-readable instructions) that causes CPU 31 to implement the stopping position control process, described hereafter. The CPU 31 functions as a detecting unit 31a and a changing unit 31b by performing the stopping position control process. A relationship between the detecting unit 31a and the changing unit 31b, and each step of the stopping position control process will be described hereafter in the description of the embodiment.

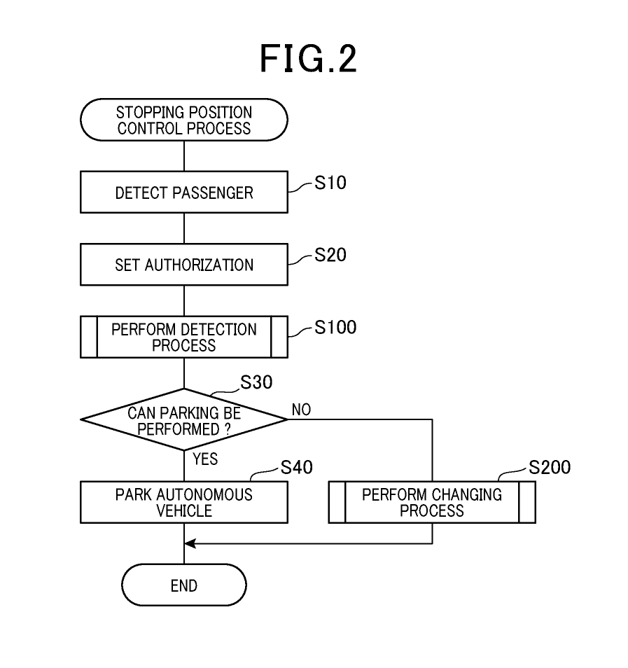

When the autonomous vehicle 10 is traveling by automated driving and a destination is set, the CPU 31 starts the stopping position control process shown in FIG. 2 based on a trigger. The trigger is the arrival of the autonomous vehicle 10 in the vicinity of the destination. Here, the vicinity of the destination refers to when the distance to the destination is within a distance that serves as a threshold and is set in advance, and the destination is within an imaging range of the front camera 23.

The CPU 31 starts the stopping position control process before the autonomous vehicle 10 reaches the destination in this manner to prevent a situation in which the stopping position control process is not started when the autonomous vehicle 10 is physically unable to enter the destination due to the presence of another vehicle or the like. According to another embodiment, the CPU 31 may start the stopping position control process with arrival at a destination G1 as the trigger.

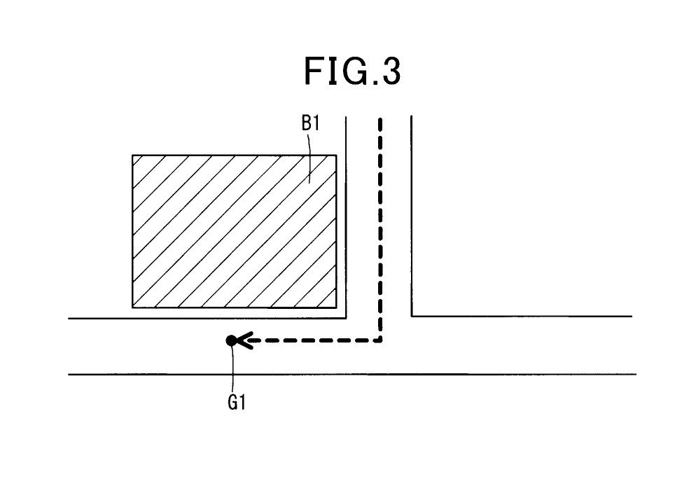

For example, as shown in FIG. 3, the driver may set the destination to a building B1. When the autonomous vehicle 10 is unable to enter the building B1, the destination G1 that serves that is an endpoint of a traveling route is set on a road in the vicinity of the building B1. The destination G1 is set to a location at which stopping is presumed to be possible, by the map data MP being referenced. However, even in cases in which whether stopping is possible is unknown even when the map data MP is referenced or stopping is presumed to not be possible when the map data MP is referenced, the destination G1 is temporarily set in the vicinity of the building B1. Hereafter, the term “destination” alone refers to a destination, such as the destination G1, that is set as a position in which the autonomous vehicle 10 is able to enter.

First, at step S10, the CPU 31 detects information related to passengers. Specifically, the CPU 31 detects whether a driver has boarded, and whether a passenger other than a driver has boarded. The process of step S10 is performed based on a recognition result of the captured image captured by the vehicle-interior camera 22 (vehicle-interior recognition result) and a measurement value from the vehicle weight sensor 27. According to another embodiment, a passenger may be detected by a weight sensor that is provided in each seat.

In addition, when determined that at least a single passenger is present, the CPU 31 detects information on the passenger that is related to parking and stopping. For example, the information related to parking and stopping refers to information that indicates whether a requirement that may affect whether parking and stopping can be performed is met. That is, the information indicates whether the passenger is elderly, pregnant, has a disability, or the like.

For example, the CPU 31 actualizes the detection by acquiring personal information that identifies the passenger through the authentication apparatus 29 and referencing a database that is stored in an external apparatus using the communication apparatus 21. The personal information may be a driver's license. Alternatively, the personal information may be a physical feature. A face, an iris of an eye, a fingerprint, or the like may be used as the physical feature.

Next, the CPU 31 proceeds to step S20. The CPU 31 sets authorization related to parking and stopping based on the detected information on the passenger. That is, the CPU 31 sets whether the passenger has general authorization or authorization that permits parking and stopping as an exception due to the above-described requirement being met. Such authorization is prescribed by law. When no passenger is present, the CPU 31 sets the authorization to general authorization.

According to another embodiment, when no passenger is present, the CPU 31 may change the authorization based on a positional relationship among the vehicle, a person who is performing settings, and the destination. When the person who is performing input and the vehicle are in the same location, and the destination is inputted without passengers, the CPU 31 may set the authorization to general authorization. When settings are performed by remote operation and the location of the person who is performing the settings is inputted as the destination, the CPU 31 may read the authorization of the person who is performing the settings and set this authorization as the authorization.

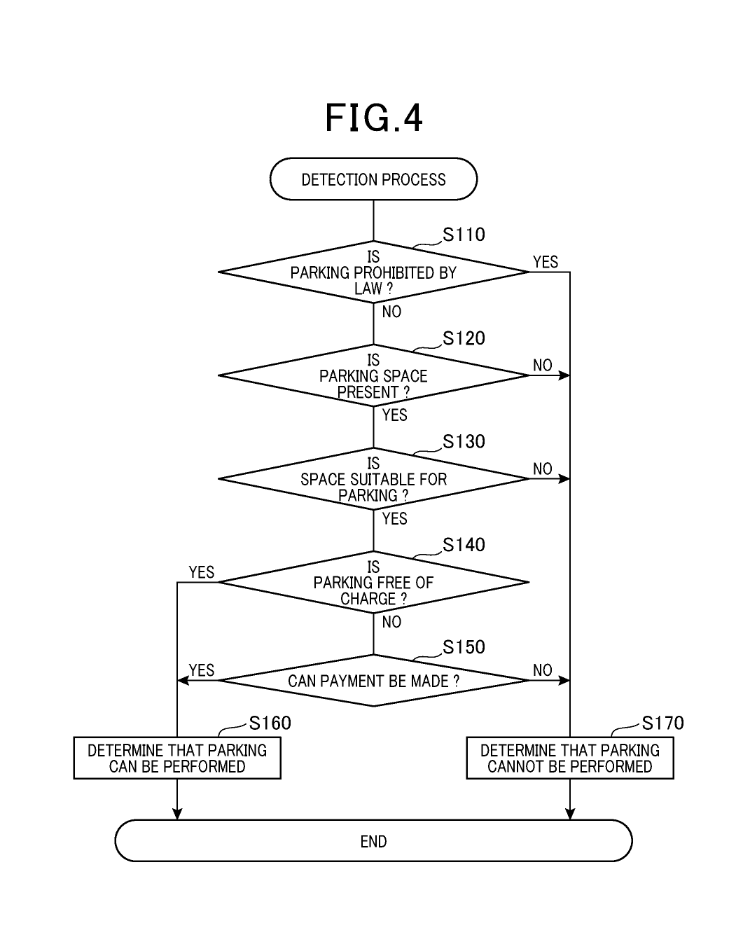

Next, the CPU 31 proceeds to step S100 and performs a detection process shown in FIG. 4. The CPU 31 proceeds to step S110 and determines whether the location that is set as the destination is a location at which parking is prohibited by law. The CPU 31 performs the determination at step S110 based on the recognition results (hereafter, vicinity recognition results) of the captured images captured by the front camera 23 and the rear camera 24, and the map data MP.

Examples of locations at which parking is prohibited by law are given below.

(1) no-entry locations: sidewalks, pedestrian zones, and the like.

(2) no-parking/stopping zones: for example, such locations include:

(2A) a location where a mark or a road sign that indicates no parking or stopping is present;

(2B) at an intersection, a pedestrian crossing, and a bicycle crossing zone;

(2C) on a track bed, that is, on the tracks of a streetcar or the like;

(2D) near the top of a slope and on a steep slope;

(2E) inside a tunnel;

(2F) within 5 meters of the outside edges of an intersection or a bend in the road;

(2G) the left side of a safety zone, and within 10 meters in front of and behind the front and rear edges of the safety zone;

(2G) within 10 meters of a sign post for a bus stop or a streetcar station;

(2I) a railroad crossing and within 10 meters in front of and behind the front and rear edges of the railroad crossing;

(2J) within 5 meters in front of and behind the front and rear edges of a pedestrian crossing or a bicycle crossing zone; and

(2K) an expressway or an automobile road (excluding parking areas).

(3) No-parking zones: for example, applicable locations include:

(3A) a location where a mark indicating no parking is present;

(3B) within a 3-meter radius of a vehicle entrance/exit such as for a parking lot or a garage;

(3C) within a 5-meter radius of the outside edges of a road construction zone;

(3D) within a 5-meter radius of the outside edges and an entrance/exit of a storage facility for firefighting equipment or a water tank for use in firefighting;

(3E) within a 5-meter radius of a fire hydrant, a sign indicating a designated water source for use in firefighting, or the like;

(3F) within a 1-meter radius of a fire alarm; and

(3G) a location where no space of 3.5 meters or more is present on the road to the right side of the vehicle.

When determined that parking is prohibited by law, the CPU 31 determines YES at step S110 and proceeds to step S170. The CPU 31 determines that the autonomous vehicle 10 cannot be parked at the destination and ends the detection process.

Meanwhile, when determined that parking is not prohibited, the CPU 31 determines NO at step S110 and proceeds to step S120. The CPU 31 determines whether space for parking is present at the destination. The autonomous vehicle 10 is parked at the destination under a condition that the autonomous vehicle 10 is stopped in a position at which a distance between the point that is set as the destination and the center of the body of the autonomous vehicle 10 is within a predetermined distance. This similarly applies to when the autonomous vehicle 10 is stopped.

When determined that no space for parking is present, the CPU 31 determines NO at step S120 and proceeds to step S170.

Examples of cases in which no space for parking is present include:

(4A) a location in which a step is present, a location that is under construction, a location that is damaged, such as caved in, or a scene of an accident;

(4B) a parking area in which the vehicle is not permitted to park (such as a parking area of another person);

(4C) a location that is narrow in width and of which the space in which the vehicle enters is small;

(4D) a location in which a traffic cone indicating no parking or no entry, or the like is set; and

(4E) when the vehicle is to be parked on a street, a road shoulder that is filled with parked cars.

The CPU 31 performs the determination at step S120 based on the vicinity recognition results. When determined that space for parking is present, the CPU 31 determines YES at step S120 and proceeds to step S130. The CPU 31 determines whether the space for parking is suitable for parking. The CPU 31 performs the determination at step S130 based on the vicinity recognition results. Examples of cases in which the space is not suitable for parking are given below. According to the present embodiment, the CPU 31 determines that the space is suitable for parking when the following is not applicable.

(5A) Visibility is poor and the risk of collision or the like is high, such as a space on a curve or at a location at which a flat or inclining portion of a protruding section changes to a decline;

(5B) the space is on a steep slope;

(5C) a puddle, debris, or the like (that inhibit walking or make walking unpleasant) is present at a boarding/exiting location;

(5D) the space is on an unpaved road where shoes may become soiled by mud or the like when walked on;

(5E) when the vehicle is to be parked on a street, the road shoulder is narrow;

(5F) when a passenger who is planning to exit the vehicle is present or a person who is planning to board the vehicle is present, the space is narrow, making opening and closing of doors, and boarding and exiting the vehicle, difficult.

According to another embodiment, whether above-described (5C) and (5D) are applicable may be determined by a passenger. When the passenger determines that the space is not suitable for parking or a response cannot be acquired before the autonomous vehicle 10 reaches a predetermined location, the CPU 31 determines that the space is not suitable for parking, that is, determines NO at step S130.

When determined that the space is not suitable for parking, the CPU 31 determines NO at step S130 and proceeds to step S170. Meanwhile, when determined that the space is suitable for parking, the CPU 31 determines YES at step S130 and proceeds to step S140. The CPU 31 then determines whether the autonomous vehicle 10 can be parked free of charge. Parking free of charge refers to cases in which an additional fee is not generated at the time of determination by the autonomous vehicle 10.

For example, such cases include parking in a parking lot with which the autonomous vehicle 10 has a lease agreement in advance, such as a month-to-month agreement. When determined that the autonomous vehicle 10 can be parked free of charge, the CPU 31 determines YES at step S140 and proceeds to step S160. The CPU 31 determines that the autonomous vehicle 10 can be parked and ends the detection process.

Meanwhile, when determined that the parking area is a paid parking area, the CPU 31 determines NO at step S140 and proceeds to step S150. The CPU 31 then determines whether payment can be made. When no person has boarded the autonomous vehicle 10, the payment can be made when the following conditions are met. That is, permission is granted by a payer and a settlement means is operated.

Settlement according to the present embodiment is performed through use of a wireless communication service using the communication apparatus 21. Therefore, when the current location is outside the service area of the wireless communication service, the payment cannot be made. When a person has boarded the autonomous vehicle 10, at step S150, the CPU 31 asks the passenger whether to park in the paid parking area, through the interface 50. The CPU 31 performs the determination at step S150 based on a result inputted by the passenger.

When determined that payment can be made, the CPU 31 determines YES at step S150 and proceeds to step S160. When determined that payment cannot be made, the CPU 31 determines NO at step S150 and proceeds to step S170.

Upon completing the detection process, the CPU 31 proceeds to step S30 as shown in FIG. 2. The CPU 31 determines whether the detection result of the detection process indicates that parking can be performed. When determined that parking can be performed, the CPU 31 determines YES at step S30 and proceeds to step S40. The CPU 31 parks the autonomous vehicle 10 at the destination and ends the stopping position control process.

Meanwhile, when determined that parking cannot be performed, the CPU 31 determines NO at step S30 and proceeds to step S200. The CPU 31 performs a changing process and ends the stopping position control process. In FIG. 2, the changing process is shown as a sub-routine. Detailed contents of the sub-routine will be described according to another embodiment, described hereafter.

In the changing process according to the present embodiment, when determined that parking cannot be performed at the destination, the CPU 31 performs a measure such that a person can board or exit the autonomous vehicle 10. Specifically, the CPU 31 either parks the autonomous vehicle 10 in another location in the periphery of the initial destination, or moves the autonomous vehicle 10 to another location within 5 minutes after stopping such that the autonomous vehicle 10 is not considered to be parked. The periphery of the destination refers to an area that is wider than an area within a predetermined distance that meets the above-described conditions regarding stopping.

According to the first embodiment described above, even if the autonomous vehicle 10 is found to be unable to be parked at the location that is set as the destination upon arrival in the vicinity of the destination, a measure can be taken such that a person can board or exit the autonomous vehicle 10.

In addition, according to the first embodiment, whether parking or stopping can be performed is determined based on the authorization of the passenger. Therefore, a situation which a determination that parking or stopping cannot be performed is erroneously made when parking or stopping can rightfully be performed can be prevented.

### Second Embodiment

Next, a second embodiment will be described. The description according to the second embodiment mainly focuses on differences with the first embodiment. Points that are not particularly described are the same as those according to the first embodiment.

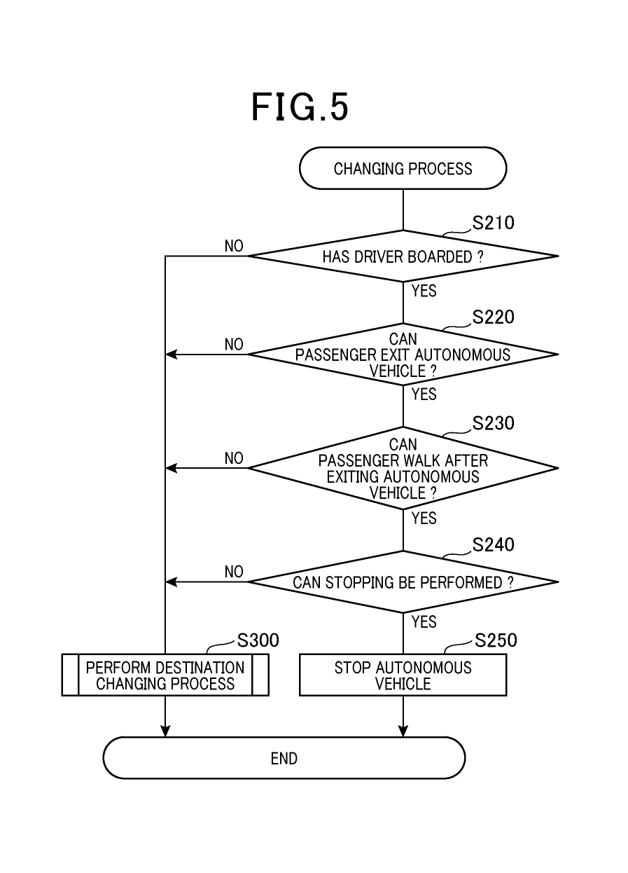

According to the second embodiment, the detailed contents of the changing process will be described. As shown in FIG. 5, the CPU 31 proceeds to step S210 and determines whether a driver has boarded the autonomous vehicle 10. The CPU 31 performs the determination at step S210 by using the captured image captured by the vehicle-interior camera 22 and the measurement value from the vehicle weight sensor 27.

When determined that a driver has boarded, the CPU 31 determines YES at step S210 and proceeds to step S220. The CPU 31 determines whether a state of the body of the passenger is a state in which the passenger can exit the autonomous vehicle 10. Here, the passenger refers to the driver and anyone who is seated in the passenger seat or the backseat. For example, a state in which the passenger cannot exit the autonomous vehicle 10 is a state in which the passenger is asleep and unconscious.

When determined that the passenger is not in such a state, the CPU 31 determines that the state of the body of the passenger is a state in which the passenger can exit the autonomous vehicle 10. The CPU 31 determines the state of the body of the passenger based on the vehicle-interior recognition result, and a body temperature, a heart rate, and an amount of activity of the passenger. The CPU 31 acquires the body temperature, the heart rate, and the amount of activity of the passenger from a wristwatch-type wearable computer (not shown) that is worn by the passenger, through wireless communication via the communication apparatus 21. According to another embodiment, the body temperature, the heart rate, and the amount of activity of the passenger may be measured by a measurement apparatus provided in the autonomous vehicle 10.

When determined that the passenger can exit the autonomous vehicle 10, the CPU 31 determines YES at step S220 and proceeds to step S230. The CPU 31 then determines whether the passenger can walk after exiting the autonomous vehicle 10. For example, the CPU 31 determines that the passenger can walk when a pedestrian area is present. The CPU 31 determines whether a pedestrian area is present based on whether a white line or a curbstone is present. The CPU 31 uses the vicinity recognition results to perform the determination. Meanwhile, when the autonomous vehicle 10 is on an automobile road, the CPU 31 determines that the passenger cannot walk. Furthermore, the CPU 31 determines that the passenger cannot walk in cases in which a sidewalk is present but is difficult to reach immediately after exit from the autonomous vehicle 10. Such cases may occur in a tunnel or the like.

When determined that the passenger can walk after exiting the autonomous vehicle 10, the CPU 31 determines YES at step S230 and proceeds to step S240. The CPU 31 determines whether the autonomous vehicle 10 can be stopped. For example, the CPU 31 determines that the autonomous vehicle 10 cannot be stopped when the location corresponds to the zones described as (1) no-entry locations or (2) no-parking/stopping zones according to the first embodiment. Furthermore, the CPU 31 determines that the autonomous vehicle 10 cannot be stopped when the road shoulder is narrower than a predetermined width or the road width is narrower than a predetermined width at step S230. The CPU 31 determines the width of the road shoulder and the road width based on the vicinity recognition results.

When determined that the autonomous vehicle 10 can be stopped, the CPU 31 determines YES at step S240 and proceeds to step S250. The CPU 31 stops the autonomous vehicle 10 and ends the changing process.

Meanwhile, when determined NO at any of steps S210 to S240, the CPU 31 proceeds to step S300. The CPU 31 performs a destination changing process and ends the changing process. In FIG. 5, the destination changing process is shown as a sub-routine. Detailed contents of the sub-routine will be described according to another embodiment, described hereafter.

In the destination changing process according to the present embodiment, when stopping of the autonomous vehicle 10 at the destination is undesirable, the CPU 31 changes the destination to a location at which parking or stopping can be performed. In addition, in the destination changing process, when determined NO at step S210, that is, when no driver has boarded the autonomous vehicle, the CPU 31 preferentially retrieves a location at which parking can be performed over a location at which stopping can be performed but parking cannot be performed as a candidate for the destination.

According to the second embodiment described above, when stopping of the autonomous vehicle 10 at the location set as the destination is found to be undesirable upon arrival in the vicinity of the destination, the destination is changed. As a result, undesirable stopping of the autonomous vehicle 10 such as that described above can be prevented.

For example, when the autonomous vehicle 10 is stopped in a case where no driver has boarded, the autonomous vehicle 10 continues to be stopped until an instruction for remote traveling is received from an external apparatus via the communication apparatus 21 or until the driver boards the autonomous vehicle 10. Thus, the autonomous vehicle 10 may be stopped for a long period of time. When the autonomous vehicle 10 is stopped for a long period of time, a parking violation may occur. According to the second embodiment, such cases can be prevented.

According to another embodiment, even if a driver has not boarded, when a predetermined condition is met, the autonomous vehicle 10 may be stopped for a predetermined amount of time. The location at which the autonomous vehicle 10 is stopped may then be corrected if a user does not approach the autonomous vehicle 10 to board the autonomous vehicle 10 while the autonomous vehicle 10 is stopped. The predetermined condition is that, after the driver exits the autonomous vehicle 10 when valet parking is being used, a destination is set to enable the driver to board the autonomous vehicle 10. When valet parking is used, the driver is likely to board the autonomous vehicle 10 at the location at which the driver initially exits the autonomous vehicle 10. Therefore, the autonomous vehicle 10 is preferably stopped at the destination to the greatest extent possible.

Furthermore, according to the second embodiment, whether the autonomous vehicle 10 can be parked or stopped is detected based on the state of the body of the passenger (such as a sleeping state of the passenger) of the autonomous vehicle 10. Therefore, whether the autonomous vehicle 10 can be parked or stopped can be appropriately determined.

### Third Embodiment

Next, a third embodiment will be described. The description according to the third embodiment mainly focuses on differences with the second embodiment. Points that are not particularly described are the same as those according to the second embodiment.

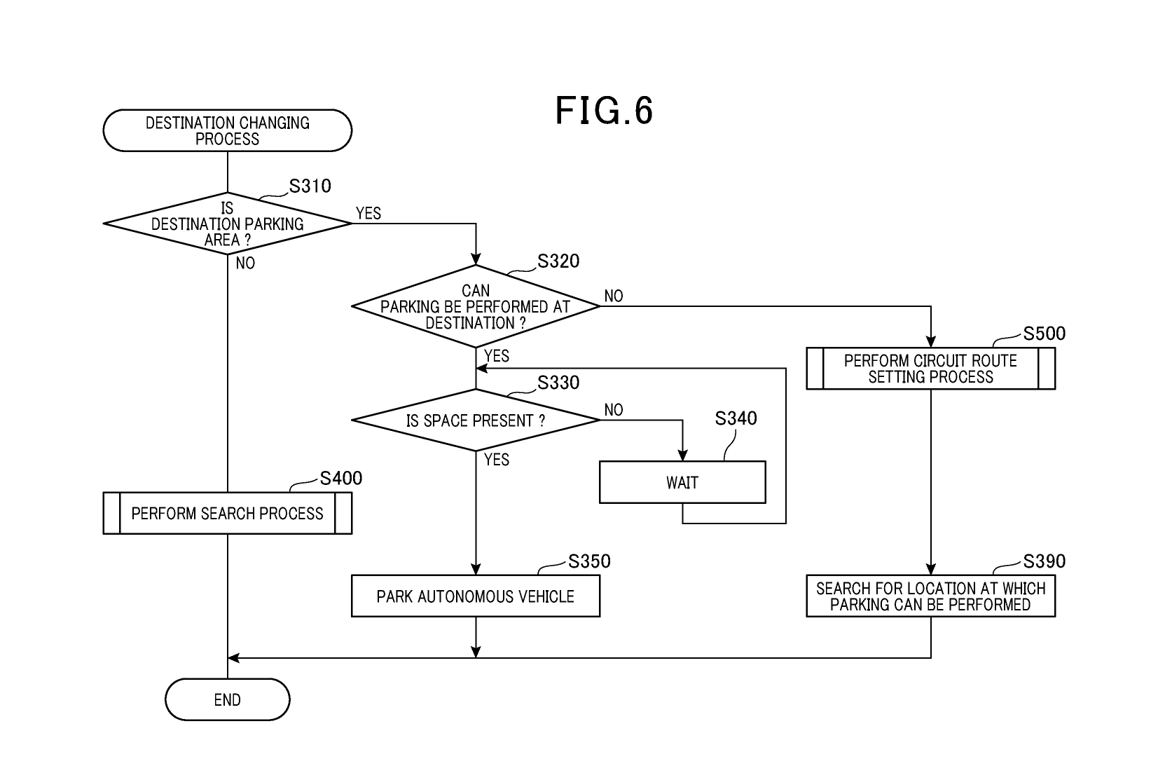

According to the present embodiment, the steps shown in FIG. 6 are performed as the destination changing process. The CPU 31 proceeds to step S310 and determines whether the destination is set to a parking area. When determined that the destination is not set to a parking area, the CPU 31 determines NO at step S310 and proceeds to step S400. The CPU 31 performs a retrieval process and ends the destination changing process.

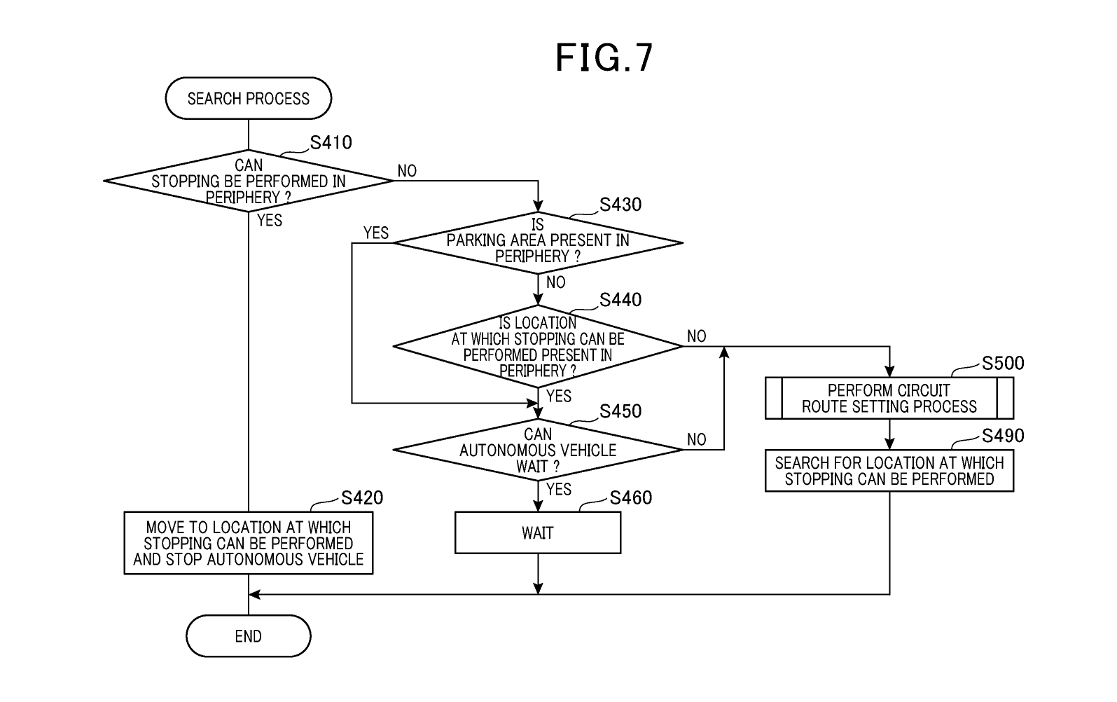

As shown in FIG. 7, upon starting the retrieval process, the CPU 31 proceeds to step S410. The CPU 31 determines whether a location at which stopping can be performed is present in the periphery of the current location. Here, the periphery of the current location corresponds to the description regarding the periphery of the destination, in which “destination” is replaced with “current location.” That is, the periphery of the current location refers to an area that is wider than an area within a predetermined distance that meets the above-described conditions regarding stopping.

The process of step S410 is performed based on the vicinity recognition results. When determined that a location at which stopping can be performed is present in the periphery of the current location, the CPU 31 determines YES at step S410 and proceeds to step S420. The CPU 31 moves the autonomous vehicle 10 to the location and parks or stops the autonomous vehicle 10. The CPU 31 then ends the retrieval process.

Meanwhile, when determined that no location at which stopping can be performed is present in the periphery of the current location, the CPU 31 determines NO at step S410 and proceeds to step S430. The CPU 31 determines whether a parking area is present in the periphery of the current location. The CPU 31 has determined that the autonomous vehicle 10 cannot be stopped at step S410. Therefore, the determination at step S430 is a determination regarding whether a full parking area is present. When determined that a parking area is present in the periphery of the current location, the CPU 31 determines YES at step S430 and proceeds to step S450. The CPU 31 determines whether the autonomous vehicle 10 can wait on a road shoulder, a vehicle path of the parking area, or the like. The CPU 31 performs the determination at S450 based on the vicinity recognition results and the map data MP.

When determined that the autonomous vehicle 10 can wait, the CPU 31 proceeds to step S460. The CPU 31 moves the autonomous vehicle 10 to the location at which the autonomous vehicle 10 can wait. The CPU 31 enters waiting state and ends the retrieval process. Subsequently, when a space becomes available, the CPU 31 parks the autonomous vehicle 10.

Meanwhile, when determined that no parking area is present in the periphery of the current location, the CPU 31 determines NO at step S430 and proceeds to step S440. The CPU 31 determines whether a location at which stopping can be performed is present in the periphery of the current location. The CPU 31 performs the determination at step S440 based on the vicinity recognition results and the map data MP. The CPU 31 has determined that the autonomous vehicle 10 cannot be stopped at step S410.

Therefore, the determination at step S440 is a determination regarding whether a location at which stopping can be performed but temporarily cannot be performed is present. A location at which stopping temporarily cannot be performed is a location at which another vehicle is stopped or the like. When determined that a location at which stopping can be performed is present in the periphery of the current location, the CPU 31 determines YES at step S440 and proceeds to step S450. When determined that the autonomous vehicle 10 can wait, the CPU 31 determines YES at step S450 and proceeds to step S460. The CPU 31 then enters a waiting state. Subsequently, when stopping can be performed, the CPU 31 stops the autonomous vehicle 10.

When determined NO at either of steps S440 and S450, the CPU 31 proceeds to step S500 and performs a circuit route setting process.

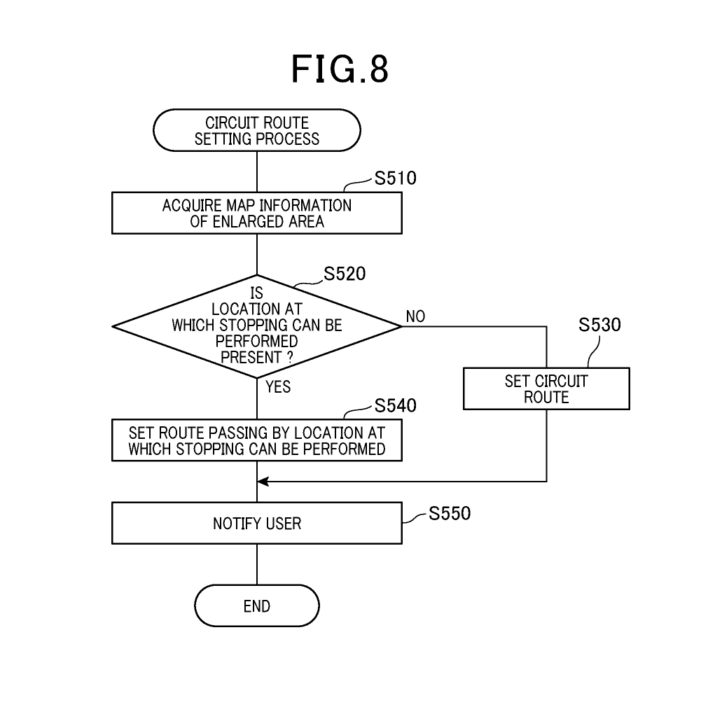

As shown in FIG. 8, upon starting the circuit route setting process, the CPU 31 proceeds to step S510. The CPU 31 acquires information related to a parking area or a location at which stopping can be performed within an enlarged area, from the map data MP. The enlarged area refers to an area of which the destination is the center and an area that is even wider than the periphery of the destination. Next, the CPU 31 proceeds to step S520 and determines whether a location at which stopping can be performed is present within the enlarged area.

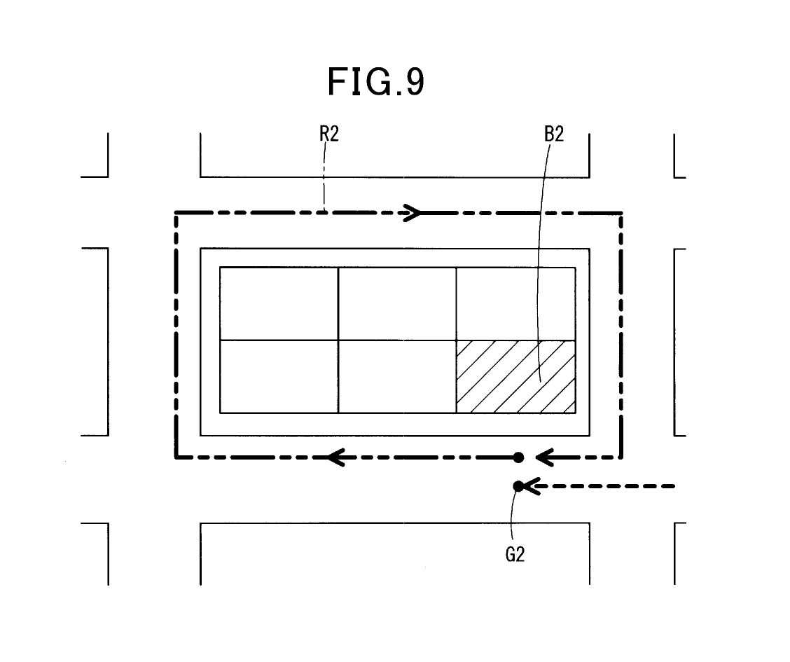

When determined that no location at which stopping can be performed is present within the enlarged area, the CPU 31 determines NO at step S520 and proceeds to step S530. The CPU 31 sets a route that makes a circuit inside the enlarged area. For example, as shown in FIG. 9, a building B2 is designated as the destination and a destination G2 is set as the actual destination. In such cases, a route that passes by and circuits the destination G2 is set.

For example, as in FIG. 9, a route R2 that circuits a block including the building B2 is set. When the autonomous vehicle 10 is called to enable a person to board during valet parking or when a passenger is in a state in which the passenger cannot exit the autonomous vehicle 10 (such as being asleep), the autonomous vehicle 10 is highly likely to be near the destination when the state becomes such that boarding or exiting the autonomous vehicle 10 becomes possible. The autonomous vehicle 10 can be quickly stopped at the location intended by the user.

Meanwhile, when determined that a location at which stopping can be performed is present within the enlarged area, the CPU 31 determines YES at step S520 and proceeds to step S540. The CPU 31 sets a route that passes by this location. However, as a rule, the location at which stopping can be performed in this case refers to a location at which stopping is not prohibited. That is, at step S520, the CPU 31 does not determine whether the state is such that stopping cannot be performed because another vehicle is stopped or the like.

At S540 according to the present embodiment, when a plurality of locations at which stopping can be performed are present, the CPU 31 sets a route that passes by all of the locations. When a plurality of locations at which stopping can be performed are present, the CPU 31 sets a route that passes by the locations in order from the parking area that is closest in distance to the initial destination.

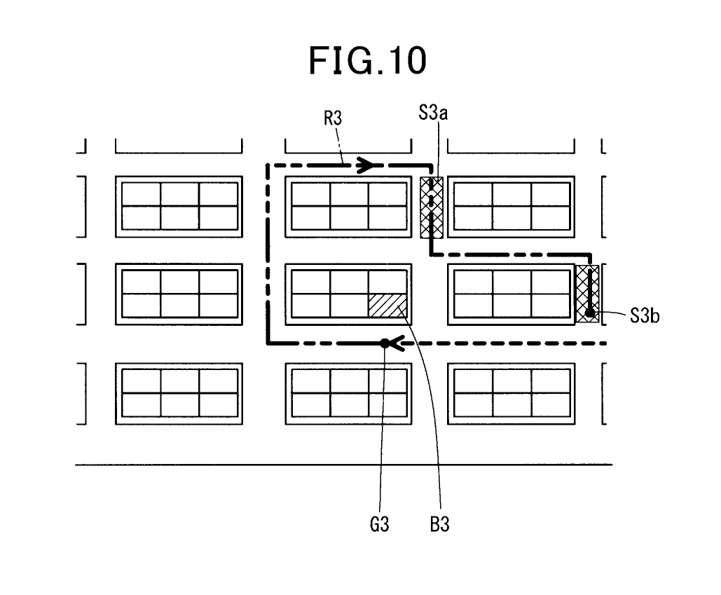

For example, as shown in FIG. 10, a building B3 is designated as the destination and a destination G3 is set as the actual destination. In such cases, when locations S3a and S3b are present as the locations at which stopping can be performed within the enlarged area, the CPU 31 sets a route R3 as a route that passes by the locations S3a and S3b.

After performing either of S530 and S540, the CPU 31 proceeds to S550. The CPU 31 notifies the user of the route that has been set and ends the circuit route setting process. The user according to the present embodiment refers to the driver when the driver has boarded the autonomous vehicle 10. When no driver has boarded the autonomous vehicle 10, the user is a person who is planning to board the autonomous vehicle 10. When the user being notified is the driver, the interface 50 is used for the notification at S550. When the user being notified is a person who is planning to board the autonomous vehicle 10, the communication apparatus 21 is used for the notification at S550.

The communication apparatus 21 transmits the information related to the above-described route that has been set to a communication terminal belonging to the person who is planning to board the autonomous vehicle 10. Specifically, the communication apparatus 21 transmits a notification that the autonomous vehicle 10 cannot be stopped at the initial destination, information on the route that has been newly set, and positional information on candidates for a stopping location (such as the locations S3a and S3b).

Upon completing the circuit route setting process, the CPU 31 proceeds to S490. The CPU 31 makes the autonomous vehicle 10 travel to search for the location at which stopping can be performed. Each time the autonomous vehicle 10 approaches a candidate for the stopping location, the CPU 31 determines whether the autonomous vehicle 10 can stop at the candidate location. When determined that the autonomous vehicle 10 can stop at the candidate location, the CPU 31 stops the autonomous vehicle 10.

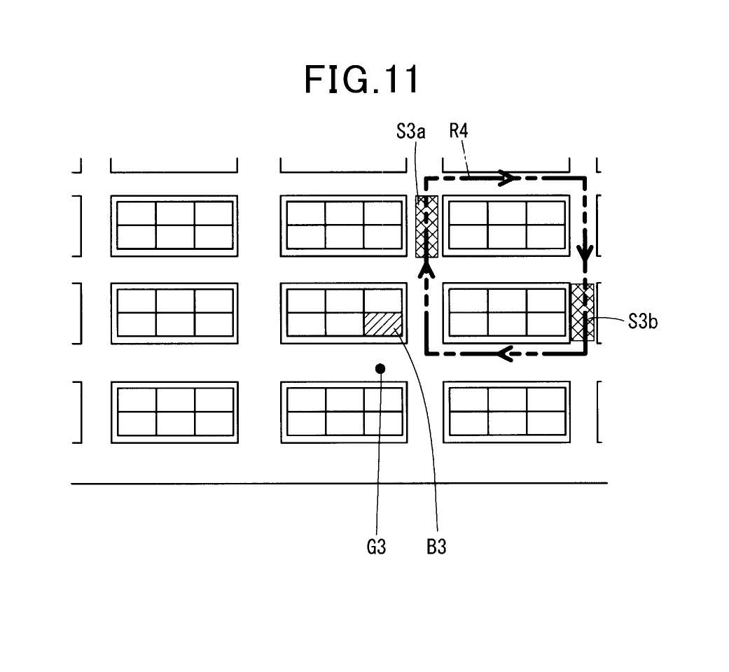

Meanwhile, when the autonomous vehicle 10 reaches the vicinity of the candidate location for the stopping location as described above and the CPU 31 determines that the autonomous vehicle 10 cannot actually be stopped at the location based on the vicinity recognition results, as shown in FIG. 11, the CPU 31 newly sets a route R4 that circuits the candidate locations for the stopping location. According to another embodiment, the autonomous vehicle 10 may not be stopped even when stopping can be performed at the candidate location and, as shown in FIG. 11, a route that circuits the candidate locations may be set. The user can confirm and select the stopping location.

Meanwhile, as shown in FIG. 6, when determined that the destination is set to a parking area, the CPU 31 determines YES at S310 and proceeds to S320. The CPU 31 determines whether parking can be performed at the destination. Here, the destination changing process is performed when the CPU 31 determines NO at S30, that is, when parking cannot be performed. Therefore, as a rule, the CPU 31 also determines that parking cannot be performed at S320. For example, the CPU 31 may determine YES at S320 when, if the destination is a parking area, the autonomous vehicle 10 can wait for a brief amount of time on a vehicle path within the parking area. According to the present embodiment, the CPU 31 determines YES at S320 when, even when the autonomous vehicle 10 cannot currently be parked, parking can be performed in the future when a vacancy becomes available in the parking area, as described above.

When determined YES at S320 as described above, the CPU 31 proceeds to S330. The CPU 31 determines whether a vacancy is present in the parking area. When determined that no vacancy is present, the CPU 31 determines NO at S330 and proceeds to S340. The CPU 31 waits for a predetermined amount of time and returns to S330. When determined that a vacancy has become available in the parking area, the CPU 31 determines YES at S330 and proceeds to S350. The CPU 31 parks the autonomous vehicle 10 in the vacant space and ends the destination changing process.

Meanwhile, when determined that parking cannot be performed at the destination, the CPU 31 determines NO at S320 and proceeds to S500. The CPU 31 performs the circuit route setting process, described above. However, when the CPU 31 performs the circuit route setting process upon determining NO at S320, because the objective is to park the autonomous vehicle 10, “stopping” is replaced with “parking” in the above-described description of the circuit route setting process.

When determined that parking cannot be performed at the destination in the parking area, if the destination is the parking area as described above, the autonomous vehicle 10 can wait for a brief amount of time on a vehicle path within the parking area. Therefore, the CPU 31 determines YES at S330.

For example, cases in which the CPU 31 determines NO at S320 include cases in which the parking area is currently full and vehicles awaiting vacancy are overflowing onto the street, cases in which a vacancy is presumed highly likely to not become available for a long period of time, and cases in which the parking area cannot be used due to construction or the like. For example, the CPU 31 can acquire parking time information from the parking area and event information regarding events being held in the vicinity of the parking area, and estimate the likelihood of a vacancy not becoming available for a long period of time based on the event information.

For example, when parking time is concentrated on a certain time due to an event or the like, the likelihood of a vacancy becoming available after a brief wait is presumed to be low. Therefore, the CPU 31 determines NO at S330. When the parking area is full due to a restaurant or the like being busy, the likelihood that parking will be come possible after a brief wait due to turnover is high. Therefore, the CPU 31 determines YES at S330. In this manner, even when the destination is a parking area, if the CPU 31 determines that parking cannot be performed within a predetermined amount of time, the CPU 31 determines NO at S320 and proceeds to S500.

Upon completing the circuit route setting process, the CPU 31 proceeds to S390. The CPU 31 makes the autonomous vehicle 10 travel to search for a location at which parking can be performed and ends the destination changing process. When a candidate location at which parking can actually be performed is present, the CPU 31 parks the autonomous vehicle 10 at this location.

According to the third embodiment described above, when the initial destination is a parking area, even when no location at which parking can be performed is present in the periphery of the destination, the autonomous vehicle 10 is parked by the CPU 31 preferentially searching for a location at which parking can be performed, over a location at which parking is prohibited but stopping can be performed. Therefore, a parking violation can be prevented from occurring. This effect is particularly significant when the destination changing process is performed when the CPU 31 has determined NO at S210, that is, when no driver has boarded.

### Fourth Embodiment

Next, a fourth embodiment will be described. The description according to the fourth embodiment mainly focuses on differences with the third embodiment. Points that are not particularly described are the same as those according to the third embodiment.

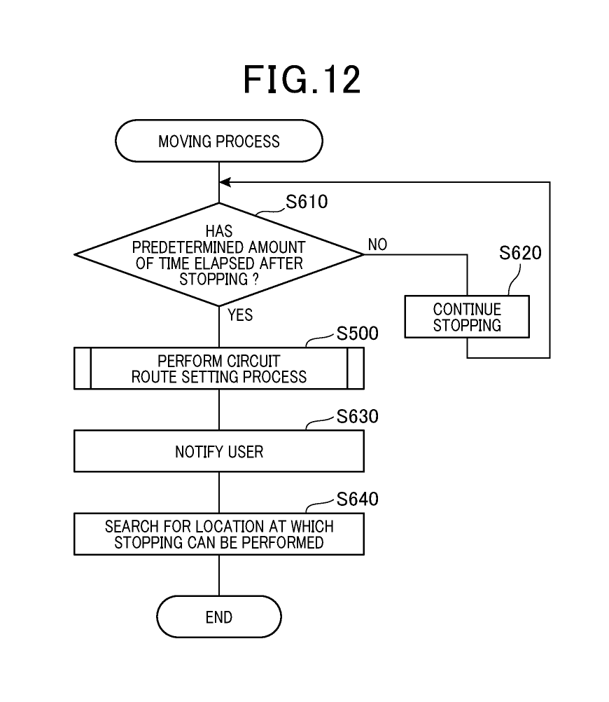

According to the present embodiment, a moving process shown in FIG. 12 is performed. The moving process is performed when the autonomous vehicle 10 is stopped at a location at which parking is prohibited, according to the above-described embodiment.

The CPU 31 proceeds to step S610 and determines whether a predetermined amount of time has elapsed after stopping the autonomous vehicle 10. For example, the predetermined amount of time may be an amount of time (such as 5 minutes) prescribed by law. Alternatively, the predetermined amount of time may be an amount of time set by the user in advance. The amount of time prescribed by law may be acquired from road information acquired from the map data MP or may be acquired by a mark being recognized as a vicinity recognition result. When the amount of time prescribed by law and the amount of time set by the user in advance do not match, either may be used.

When determined that the predetermined amount of time has not elapsed after stopping the autonomous vehicle 10, the CPU 31 determines NO at step S610 and proceeds to step S620. The CPU 31 continues the stopping of the autonomous vehicle 10 and returns to step S610.

Meanwhile, when determined that the predetermined amount of time has elapsed after stopping the autonomous vehicle 10, the CPU 31 determines YES at step S610 and proceeds to step S500. The CPU 31 performs the circuit route setting process, described above. The CPU 31 ends the stopping of the autonomous vehicle 10 and starts traveling as a result of a new route being set.

Next, the CPU 31 proceeds to step S630 and notifies the user that traveling has started. Then, the CPU 31 proceeds to step S640 while traveling. The CPU 31 searches for a location at which stopping can be performed and ends the moving process.

According to the fourth embodiment, when the autonomous vehicle 10 is stopped at a location at which parking is prohibited, a parking violation can be prevented from occurring.

Corresponding relationships between the embodiments and the claims will be described. The detection process corresponds to the detecting unit 31a. The changing process corresponds to the changing unit 31b.

The present disclosure is not limited to the embodiments in the present specification and may be actualized by various configurations without departing from the spirit of the invention. For example, technical features according to the embodiments that correspond to technical features according to aspects described in the summary of the invention can be replaced or combined as appropriate to solve some or all of the above-described issues or achieve some or all of the above-described effects. The technical features may be omitted as appropriate unless described as a requisite in the present specification. For example, the following embodiments can be given as examples.

According to the above-described embodiments, some or all of the functions and processes implemented by software may be actualized by hardware. In addition, some or all of the functions and processes actualized by hardware may be actualized by software. For example, as hardware, various circuits, such as integrated circuits, discrete circuits, and circuit modules combining integrated circuits and discrete circuits, may be used.

The determinations at steps S30 and S320 may be performed only when valet parking is used.

At step S530, when a storage location at which the autonomous vehicle 10 can be parked with certainty, such as a parking area at home, is present within a predetermined distance, a route returning to the storage location may be set.

In addition, according to another embodiment, at step S530, when no location at which stopping can be performed is present after the autonomous vehicle 10 travels the circuit route a predetermined number of times, a route returning to the storage location may be set.

Alternatively, when no location at which stopping can be performed is present after the autonomous vehicle 10 circuits the circuit route a predetermined number of times, a route returning to the storage location may be set when the storage location is within a predetermined distance.

At step S540, a route returning to the initial destination may be set. The stopping location may then be set after all of the candidate locations for the stopping location are once checked.

At step S540, when vacancy information regarding the candidate locations for the stopping location can be acquired by communication or the like, a vacant parking area that is nearby or a parking area with many vacancies may be set. Alternatively, the determination can be made taking into total consideration the vacancy information, the fee, and the distance from the destination. When a vacant space is determined to not be present at a location at which stopping can be performed on the route, the route may be reset so as to exclude the location.

The vicinity recognition results may not be based solely on the imaging results of the front camera 23 and the rear camera 24. For example, the sensing results of the LIDAR 26 may also be used.

According to the above-described embodiments, the contents are based on Japanese law. However, the contents to be carried out may be changed based on other applicable laws.

What is claimed is:

1. A control apparatus for a vehicle, the control apparatus comprising:
a detecting unit that detects whether an autonomous vehicle can stop at a destination when the autonomous vehicle moves towards the destination by automatic driving and reaches a vicinity of the destination; and
a changing unit that changes a stopping position to a location other than the destination when the detecting unit detects that the autonomous vehicle cannot stop at the destination.

2. The control apparatus according to claim 1, wherein:
the detecting unit detects whether the autonomous vehicle can stop at the destination, based on authorization related to stopping of a user of the autonomous vehicle.

3. The control apparatus according to claim 2, wherein:
the detecting unit detects whether the autonomous vehicle can stop at the destination, based on a state of a body of a passenger of the autonomous vehicle.

4. The control apparatus according to claim 3, wherein:
the changing unit preferentially uses a location at which parking can be performed over a location at which stopping can be performed as the stopping position when no person has boarded the autonomous vehicle.

5. The control apparatus according to claim 4, wherein:
the autonomous vehicle includes an external sensor (20a) that acquires information on an area outside the autonomous vehicle; and
the detecting unit performs detects whether the autonomous vehicle can stop at the destination, by analyzing the information acquired by the external sensor in the vicinity of the destination.

6. The control apparatus according to claim 5, wherein:
the detecting unit detects whether the autonomous vehicle can stop at the destination, by analyzing a state of a road surface by analyzing the information acquired by the external sensor and determining whether the road surface is suitable for walking.

7. The control apparatus according to claim 6, wherein:
the changing unit sets a traveling route to search for a position at which stopping can be performed to change the stopping position to a location other than the destination.

8. The control apparatus according to claim 1, wherein:
the detecting unit detects whether the autonomous vehicle can stop at the destination, based on a state of a body of a passenger of the autonomous vehicle.

9. The control apparatus according to claim 1, wherein:
the changing unit preferentially uses a location at which parking can be performed over a location at which stopping can be performed as the stopping position when no person has boarded the autonomous vehicle.

10. The control apparatus according to claim 1, wherein:
the autonomous vehicle includes an external sensor (20a) that acquires information on an area outside the autonomous vehicle; and
the detecting unit detects whether the autonomous vehicle can stop at the destination, by analyzing the information acquired by the external sensor in the vicinity of the destination.

11. The control apparatus according to claim 10, wherein:
the detecting unit detects whether the autonomous vehicle can stop at the destination, by analyzing a state of a road surface by analyzing the information acquired by the external sensor and determining whether the road surface is suitable for walking.

12. The control apparatus according to claim 1, wherein:
the changing unit sets a traveling route to search for a position at which stopping can be performed to change the stopping position to a location other than the destination.

13. A control system for a vehicle, the control system comprising:
a processor;
a non-transitory computer-readable storage medium; and
a set of computer-readable instructions stored in the computer-readable storage medium that when read and executed by the processor, cause the processor to implement:
detecting whether an autonomous vehicle can stop at a destination when the autonomous vehicle moves towards the destination by automatic driving and reaches a vicinity of the destination; and
changing a stopping position to a location other than the destination when it is detected that the autonomous vehicle cannot stop at the destination.

14. A control method for a vehicle, the control method comprising:
detecting whether an autonomous vehicle can stop at a destination when the autonomous vehicle moves towards the destination by automatic driving and reaches a vicinity of the destination; and
changing a stopping position to a location other than the destination when it is detected that the autonomous vehicle cannot stop at the destination.
